(19) United States
(12) Patent Application Publication
(10) Pub. No.: US 2017/0054897 A1
(43) Pub. Date: Feb. 23, 2017

(54) METHOD OF AUTOMATICALLY FOCUSING ON REGION OF INTEREST BY AN ELECTRONIC DEVICE

(71) Applicant: Samsung Electronics Co., Ltd., Suwon-si (KR)

(72) Inventors: Sabari Raju SHANMUGAM, Bengaluru (IN); Parijat Prakash PRABHUDESAI, Bengaluru (IN); Jin-hee NA, Seoul (KR); Pyo-jae KIM, Suwon-si (KR); Ritesh MISHRA, Bengaluru (IN)

(21) Appl. No.: 15/240,489

(22) Filed: Aug. 18, 2016

(30) Foreign Application Priority Data
Aug. 21, 2015 (IN) 4400/CHE/2015

(51) Int. Cl. H04N 5/232; G06K 9/46; G06T 7/00

(52) U.S. Cl. CPC H04N 5/23212; H04N 5/23293; G06T 7/0081; G06K 9/4604; G06T 7/0051; G06T 2207/10024

(57) ABSTRACT

A method of automatically focusing on a region of interest (ROI) by an electronic device is provided. The method includes extracting at least one feature from at least one candidate ROI in a field of view (FOV) in the electronic device, displaying at least one indicia for the at least one candidate ROI based on the at least one feature, receiving a selection of at least one ROI from among the at least one candidate ROI for which the at least one indicia is displayed; and focusing on the at least one ROI according to the selection.

### CROSS-REFERENCE TO RELATED APPLICATION(S)

This application claims the benefit under 35 U.S.C. §119(e) of an Indian Provisional application filed on Aug. 21, 2015 in the Indian Patent Office and assigned Serial No. 4400/CHE/2015, and under 35 U.S.C. §119(a) of an Indian patent application filed on Apr. 15, 2016 in the Indian Patent Office and assigned Serial No. 4400/CHE/2015, the entire disclosure of each of which is hereby incorporated by reference.

### TECHNICAL FIELD

The present disclosure relates to an autofocus system. More particularly, the present disclosure relates to a mechanism for automatically focusing on a region of interest (ROI) by an electronic device.

### BACKGROUND

Automatic-focusing cameras are well known in the art. In a camera of the related art, a viewfinder displays a field of view (FOV) of the camera and an area in the FOV is a focus area. Although automatic-focusing cameras are widely used, auto-focusing of the related art does have its shortcomings.

One particular drawback of automatic-focusing cameras is the tendency for the focus area in the FOV to be fixed. Typically, the focus area is located towards the center of the FOV and the location cannot be modified. Although such a configuration may be suitable for most situations where the object of an image to be captured is in the center of the FOV, occasionally a user may wish to capture an image in which the object is offset from or at a position different from the center of the FOV. In such a case, the object tends to be blurred when capturing the image because the camera automatically focuses only on the above-mentioned focus area, regardless of the position of the object.

In systems and methods of the related art, cameras use point or grid-based regions, coupling contrast comparison with focal sweep (multiple captures) to determine the regions for auto-focus. These methods are expensive and not without faults, as the methods provide focal codes for the regions, rather than the object, and are mostly biased towards the center of the FOV of the camera. Further, these methods may end up focusing on objects other than the more visually salient objects in a scene and require user effort to focus the camera on those visually salient objects. Further, systems and methods of the related art are prone to errors due to focusing on the wrong object, failure to focus on moving objects, a lack of auto focus points corresponding to the object, low contrast levels, inaccurate touch regions, and failure to focus on a subject located too close to a camera.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a mechanism for automatically focusing on a region of interest (ROI) by an electronic device.

In accordance with an aspect of the present disclosure, a method of automatically focusing on an ROI by an electronic device is provided. The method includes extracting at least one feature from at least one candidate ROI in a field of view (FOV) in the electronic device, displaying at least one indicia for the at least one candidate ROI based on the at least one feature, receiving a selection of at least one ROI from among the at least one candidate ROI for which the at least one indicia is displayed, and focusing on the at least one ROI according to the selection.

In accordance with another aspect of the present disclosure, a method of automatically focusing on an ROI by an electronic device is provided. The method includes determining at least one candidate ROI in an FOV of a sensor based on a red, green, blue (RGB) image, and at least one of a depth and a phase-based focal code, and displaying at least one indicia for the at least one candidate ROI.

In accordance with another aspect of the present disclosure, an electronic device for automatically focusing on an ROI is provided. The electronic device includes a sensor and a processor configured to extract at least one feature from at least one candidate ROI in a field of view (FOV) in the electronic device, cause to display at least one indicia for the at least one candidate ROI based on the at least one feature, receive a selection of at least one ROI from among the at least one candidate ROI for which the at least one indicia is displayed, and focus on the at least one ROI according to the selection.

In accordance with another aspect of the present disclosure, an electronic device for automatically focusing on an ROI is provided. The electronic device includes a sensor and a processor configured to determine at least one candidate ROI in an FOV of the sensor based on an RGB image, and at least one of a depth and a phase-based focal code, and display at least one indicia for the at least one candidate ROI.

In accordance with another aspect of the present disclosure, a computer program product comprising computer executable program code recorded on a non-transitory computer readable storage medium is provided. The computer executable program code when executed causes actions including determining, by a processor in an electronic device, at least one candidate ROI in an FOV of the sensor, determining a depth of the at least one candidate ROI, and displaying at least one indicia for the at least one candidate ROI, where the indicia indicates the depth of the at least one candidate ROI.

In accordance with another aspect of the present disclosure, a computer program product comprising computer executable program code recorded on a non-transitory computer readable storage medium is provided. The computer executable program code when executed causes actions including determining at least one candidate ROI in an FOV of a sensor based on an RGB image, a depth, and a phase-based focal code, and displaying at least one indicia for the at least one candidate ROI.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF DRAWINGS

These above and other aspects, features, and advantages of certain embodiments of the present disclosure will become more apparent from the following description taken in conjunction with the accompanying drawings, in which:

FIG. 1 illustrates various units or components included in an electronic device for automatically focusing on a region of interest (ROI), according to an embodiment of the present disclosure;

FIG. 2A is a flow diagram illustrating a method of automatically focusing on an ROI by an electronic device, according to an embodiment of the present disclosure;

FIG. 2B is a flow diagram illustrating a method of automatically focusing on an ROI by an electronic device, according to an embodiment of the present disclosure;

FIG. 2C is a flow diagram illustrating a method of automatically focusing on an ROI by an electronic device, according to an embodiment of the present disclosure;

FIG. 2D is a flow diagram illustrating a method of automatically focusing on an ROI by an electronic device, according to an embodiment of the present disclosure;

FIG. 3A is a flow diagram illustrating a method of automatically focusing on a candidate ROI having the highest weight by an electronic device, according to an embodiment of the present disclosure;

FIG. 3B is a flow diagram illustrating a method of determining at least one candidate ROI, according to an embodiment of the present disclosure;

FIG. 3C is a flow diagram illustrating a method of computing a weight for at least one candidate ROI, according to an embodiment of the present disclosure;

FIGS. 4A to 4C illustrate an example of computing a weight of at least one candidate ROI using feature data of stored images, according to various embodiments of the present disclosure;

FIGS. 5A and 5B illustrate an example of identifying phase-based focal codes, according to various embodiments of the present disclosure;

FIGS. 6A to 6C illustrate an example of displaying at least one indicia for each candidate ROI, according to various embodiments of the present disclosure;

FIGS. 7A to 7D illustrate an example of displaying at least one candidate ROI for user selection, according to various embodiments of the present disclosure;

FIGS. 8A 8C illustrate an example of displaying candidate ROIs with a selection box for user selection, according to various embodiments of the present disclosure;

FIGS. 9A and 9B illustrate an example of automatically focusing on an ROI having the highest weight, according to various embodiments of the present disclosure;

FIG. 10 illustrates an example of a macro shot with capture, according to an embodiment of the present disclosure; and

FIG. 11 illustrates a computing environment implementing a method and system for automatically focusing on an ROI by an electronic device, according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The principal object of the example embodiments herein is to provide a mechanism for automatically focusing on a region of interest (ROI) by an electronic device.

Another object of the example embodiments herein is to provide a mechanism for extracting at least one feature from at least one candidate ROI in a field of view (FOV) in an electronic device, displaying at least one indicia for the at least one candidate ROI based on the at least one feature, receiving a selection of at least one ROI from among the at least one candidate ROI for which the at least one indicia is displayed, and focusing on the at least one ROI according to the selection.

Another object of the example embodiments herein is to provide a mechanism for determining a depth of the at least one candidate of ROI, and computing a weight for the at least one candidate ROI based on the at least one feature, wherein the at least one indicia indicates at least one of the depth of the at least one candidate ROI, the at least one feature and the weight.

Another object of the example embodiments herein is to provide a mechanism for determining the at least one candidate ROI in the FOV of the sensor based on a red, green, blue (RGB) image, a depth, and phase-based focal code.

Another object of the example embodiments herein is to provide a mechanism for displaying the at least one indicia for the at least one candidate ROI.

Another object of the example embodiments herein is to provide a mechanism for using statistics of different types of images categorized based on content such as scenery, animals, people, or the like.

Another object of the example embodiments herein is to provide a mechanism for detecting a depth of a first object in the FOV of the sensor, a depth of a second object in the FOV of the sensor, and a depth of a third object in the FOV of the sensor.

Another object of the example embodiments herein is to provide a mechanism for ranking the first object higher than the second object and the third object in the FOV when the depth of the first object is less than the depth of the second object and the depth of the third object.

The example embodiments herein disclose a method of automatically focusing on an ROI by an electronic device. The method includes determining at least one candidate ROI in an FOV of the sensor, extracting a plurality of features from the at least one candidate ROI, computing a weight for the at least one candidate ROI based on at least one feature among the plurality of features, and displaying at least one indicia for the at least one candidate ROI based on the weight.

The example embodiments herein disclose a method of automatically focusing on an ROI by an electronic device. The method includes determining at least one candidate ROI in an FOV of the sensor and a depth of the at least one candidate ROI. Further, the method includes displaying at least one indicia for the at least one candidate ROI, where the indicia indicates the depth of the at least one candidate ROI.

In an example embodiment, displaying the at least one indicia for the at least one candidate ROI includes extracting a plurality of features from each candidate ROI. Further, the method includes computing a weight for each candidate ROI by aggregating the features. Further, the method includes displaying the at least one indicia for the at least one candidate ROI based on the weight.

In an example embodiment, the features include at least one of region variance, color distribution, a facial feature, a region size, a category score, a focal distance, a speed of an object included in the at least one candidate ROI, a size of the object, a category of the object, and feature data of stored images.

In an example embodiment, determining the at least one candidate ROI in the FOV of the sensor includes detecting an RGB image, phase data, and a phase-based focal code. Further, the method includes identifying a plurality of clusters included in the RGB image. Further, the method includes ranking each of the clusters according to phase-based focal codes corresponding to the clusters. Further, the method includes determining at least one candidate ROI based on the phase-based focal codes of the plurality of clusters and a threshold focal code value. The determining of the at least one candidate ROI includes setting at least one of the clusters as a candidate ROI based on the phase-based focal codes and the threshold focal code value.

In an example embodiment, segmenting the RGB image into the plurality of clusters includes extracting the plurality of clusters from the RGB image. Further, the method includes associating each of the clusters with a phase-based focal code. Further, the method includes segmenting the RGB image based on color and phase depths of the plurality of clusters, for example, based on color and phase depth similarity (e.g., using the above described clusters and associated data).

Another example embodiment herein discloses a method of automatically focusing on the ROI by the electronic device. The method includes determining at least one candidate ROI in the FOV of the sensor based on an RGB image, at least one of a depth, and a phase-based focal code. Further, the method includes displaying the at least one indicia for the at least one candidate ROI.

In an example embodiment, the method includes displaying the at least one indicia based on the weight associated with each candidate ROI.

In an example embodiment, the at least one indicia indicates a depth of the at least one candidate ROI.

In an example embodiment, the method further comprises receiving a selection of the at least one candidate ROI based on the at least one indicia, and capturing the FOV by focusing the selected at least one candidate ROI.

In an example embodiment, with the advancement in camera sensors, phase sensors are incorporated with a complementary metal-oxide semiconductor (CMOS) or a charge-coupled device (CCD) array. The phase sensors (configured for phase detection (PD) according to two phases or four phases) can provide a pseudo depth (or phase data) of a scene in which focal codes are mapped with every depth. Further, the PD along with RGB image and the focal code mapping may be used to identify one or more objects (e.g., candidate ROIs including or corresponding to the objects) at different depths in an image. Since the data for every frame is available in real-time without any additional changes to the camera (or sensor) configuration, the data may be used for object-based focusing in still-image and video capture.

In still-capture and in macro mode in which there are many depth of fields (DOFs) (i.e., depths) and the user may have to perform multiple position or lens adjustments to identity an optimal or near optimal depth of focus for producing an image in which a desired object is in focus. By using the PD and RGB image data, the proposed method can display the objects, along with unique focal codes corresponding to the objects, to the user. Further, the user can select a best object to focus, thereby reducing the user effort.

In an example embodiment, the object information may be used for automatically determining an object to focus on based on a saliency weighting mechanism (e.g., best candidate ROI in the image), thus aiding the user to capture video while in continuous auto focus for situations where, in mechanisms of the related art, a camera enters into a focal sweep mode (e.g., multiple captures) when the scene changes, the object moves out of the FOV, or the object in the FOV moves to a different depth.

In the systems and methods of the related art, cameras use point-based or grid-based regions, where contrast comparison coupled with a focal sweep is performed to determine auto-focus regions. These systems and methods are expensive and not completely failure proof as these systems and methods provide focal codes per region, rather than per object, and are mostly biased towards the center of a camera FOV. These systems and methods are unable to focus on the more visually salient objects in the scene and will require user effort.

Unlike the systems and methods of the related art, the proposed method provides a robust and simple mechanism for automatically focusing on an ROI in the electronic device. Further, in the proposed method, ROI detection is object-based, which is more accurate than grid-based or region-based ROI detection. Further, the proposed method provides information to a user about the depth of all objects in the FOV. Further, the proposed method provides for weighting objects of interest based on features of each object, and automatically determining which object to focus on based on relevancy with respect to the object features (or characteristics).

Referring now to the figures, where similar reference characters denote corresponding features consistently throughout the figures, example embodiments are illustrated.

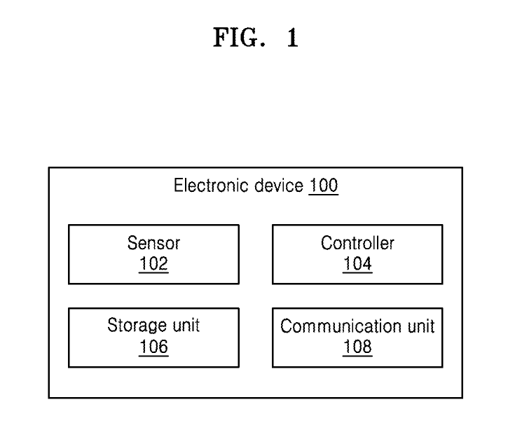

FIG. 1 illustrates various units or components included in an electronic device for automatically focusing on an ROI, according to an embodiment of the present disclosure.

Referring to FIG. 1, the electronic device 100 includes a sensor 102, a controller (i.e., processor) 104, a storage unit 106, and a communication unit 108. The electronic device 100 may be, for example, a laptop computer, a desktop computer, a camera, a video recorder, a mobile phone, a smart phone, a personal digital assistant (PDAs), a tablet, a phablet, or the like. For convenience of explanation, the sensor 102 may or may not include a processor for processing images and/or computation.

In an example embodiment, the sensor 102 and/or the controller 104 may detect an RGB image, phase data (e.g., pseudo depth or depth), and a phase-based focal code in an FOV of the sensor 102. The sensor 102 including a processor may process any of the RGB image, phase data, and phase-based focal code, or alternatively, send any of the RGB image, phase data, and phase-based focal code to the controller 104 for processing. For example, the sensor 102 or the controller 104 may extract a plurality of clusters from the RGB image and associate each of the clusters with a phase-based focal code. Further, the sensor 102 or the controller 104 may segment and/or identify the RGB image into a plurality of clusters based on color and phase depth similarity, and rank each of the clusters based on the phase-based focal code. Further, the sensor 102 or the controller 104 may determine at least one candidate ROI based on the phase-based focal codes of the plurality of clusters and a threshold focal code value. For example, the sensor 102 or the controller 104 may set one or more of the clusters as a candidate ROI based on which of the phase-based focal codes corresponding to the clusters is below the threshold focal code value, but is not limited thereto. For example, the sensor 102 or the controller 104 may set one or more of the clusters as a candidate ROI based on which of the phase-based focal codes is above the predetermined threshold focal code value, or based on which of the phase-based focal codes is within a range of focal code values. In an example embodiment, the candidate ROI is an object. In another example embodiment, the candidate ROI includes multiple objects.

Further, the sensor 102 or the controller 104 may extract at least one feature from each candidate ROI and compute a weight for each candidate ROI based on the features, for example, by aggregating the features. In an example embodiment, the features may include at least one of a region variance, a color distribution, a facial feature, a region size, a category score, a focal distance, speed of an object included in the at least one candidate ROI, a size of the object, a category of the object and feature data of stored images. The speed of an object may be important when the object—usually a person or persons moves fast such as jumping or running In such case, the fast-moving object should be set as the candidate ROI. The typical example of the category of the object is whether the object included in the candidate ROI is a human, an animal, a combination thereof, or things which do not move. A user may put much more emphasis on the moving object than things which do not move or vice versa.

In addition, a user may be able to set, select and/or classify one or more features for an autofocus function. For example, in a pro-mode, a user can see the different depths of fields on the pre-view screen and the user can select one of the depths to focus for still-capture. Further, in an auto-mode, the most salient object from the detected ROI is selected automatically by a ranking logic which relies on the face of an object, a color distribution, a focal code and a regional variance.

In another embodiment, in a setting mode, the user may select a size of the object and a category of the object as the most important indicia and a controller may control the preview screen to display indicia based the size of the object and the category of the object included in the candidate ROI. The user may also be able to set an indicia preview mode. For example, the user may limit the number of indicia and allocate any specific color to each of different indicia. The user may set and/or select a preview mode in various ways. For instance, in a user input mode, the candidate ROI will be captured by the user's input after the object with the high score indicia is displayed on the preview screen. Alternatively, the candidate ROI will be automatically captured when the object with the high score indicia is determined to be displayed on the preview screen in an automatic preview mode. In another embodiment, in the user input mode, the user may select any preferred object to be focused among a plurality of objects and the selected object will become a candidate ROI. The selected object will be captured by the user's capturing command input.

Further, the sensor 102 or the controller 104 may display at least one indicia for each candidate ROI based on weights associated with each candidate ROI. In an example embodiment, the indicia of a candidate ROI may indicate at least one of a depth of the candidate ROI, at least one feature and the computed weight. In an example embodiment, the indicia may be a color code, a number, a selection box, an alphabet letter, or the like.

In another example embodiment, the sensor 102 or the controller 104 may determine at least one candidate ROI in the FOV of the sensor based on an RGB image, a depth, and a phase-based focal code. Further, the sensor 102 or the controller 104 may display at least one indicia for each candidate ROI. In an example embodiment, the sensor 102 or the controller 104 may cause to display at least one indicia for each candidate ROI based on weights associated with each candidate ROI. Weights are computed based on the features such as face detection data, a focal code, and object properties such as entropy, color saturation, or the like of the candidate ROI.

The storage unit 106 may include one or more computer-readable storage media. The storage unit 106 may include non-volatile storage elements. Examples of such non-volatile storage elements may include magnetic hard discs, optical discs, floppy discs, flash memories, or forms of electrically programmable read-only memories (EPROMs) or electrically erasable and programmable ROMs (EEPROMs). In addition, the storage unit 106 may, in some example embodiments, be a non-transitory storage medium. The term “non-transitory” may indicate that the storage medium is not embodied as a carrier wave or a propagated signal. However, the term “non-transitory” should not be interpreted to mean that the storage unit 106 is non-movable. In some example embodiments, the storage unit 106 may store more information than the memory. In certain example embodiments, a non-transitory storage medium may store data that can change over time (e.g., random access memory (RAM) or cache). The communication unit 108 may communicate internally between the units and externally with networks.

Unlike the systems and methods of the related art, the proposed mechanism may perform object-based candidate ROI identification using phase data (or pseudo depth data) or infrared (IR) data. Further, the proposed mechanism may automatically select a candidate ROI based on a weight derived from the features (such as face detection data, a focal code, and object properties such as entropy, color saturation, or the like) of the candidate ROI. The proposed mechanism may be implemented to cover two scenarios: (1) A single object having portions located at different depths, and (2) Multiple objects lying at the same depth.

In an example embodiment, the proposed mechanism may be implemented by the electronic device 100 having an image or video acquisition capability according to phase-based or depth-based autofocus mechanisms. The sensor 102 (or capture module of a camera) may capture an image including a candidate ROI such that the candidate ROI is in focus (e.g., at a correct, desired, or optimal focal setting) sensor.

FIG. 1 shows various units included in the electronic device 100, but it is to be understood that other example embodiments are not limited thereto. In other example embodiments, the electronic device 100 may include additional or fewer units compared to FIG. 1. Further, the labels or names of the units in FIG. 1 are only for illustrative purposes and do not limit the scope of the disclosure. One or more units may be combined together to perform the same or substantially similar functions in the electronic device 100.

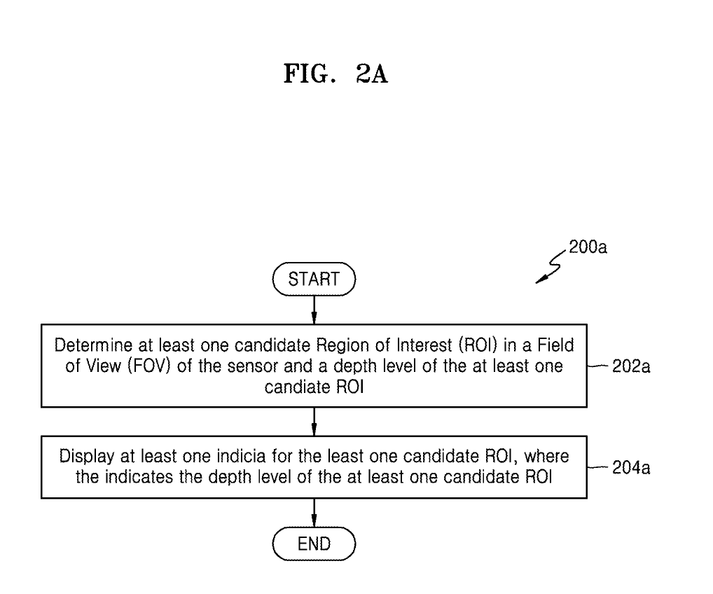

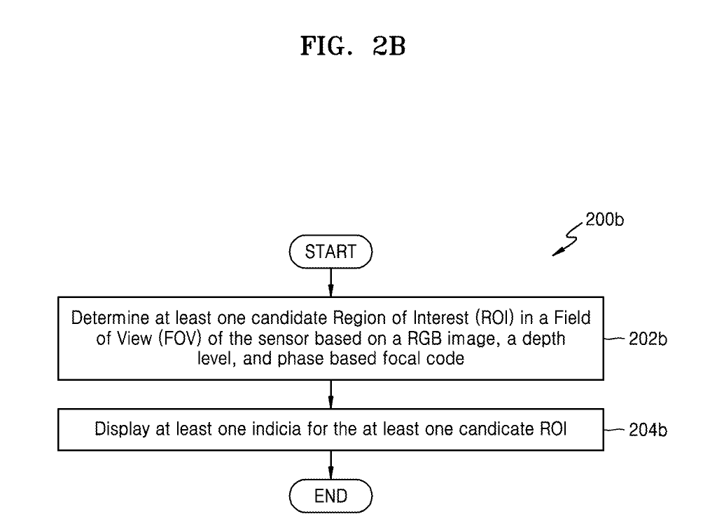

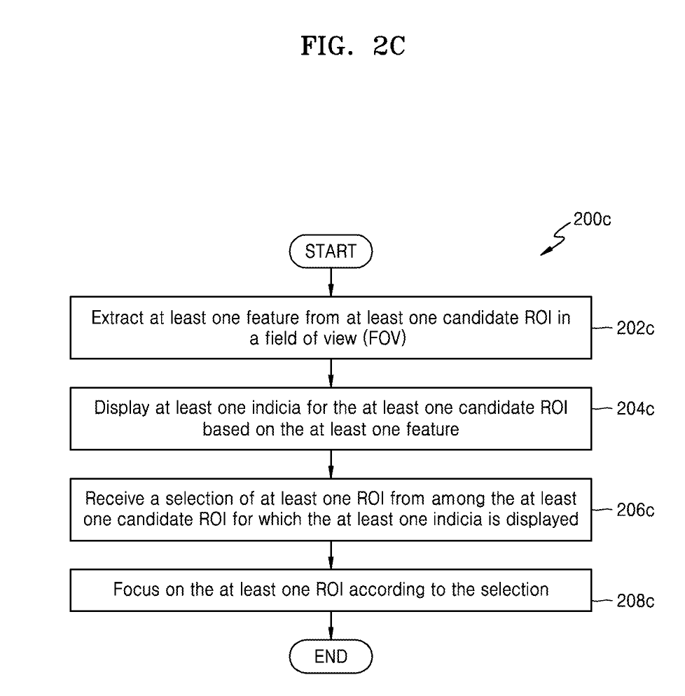

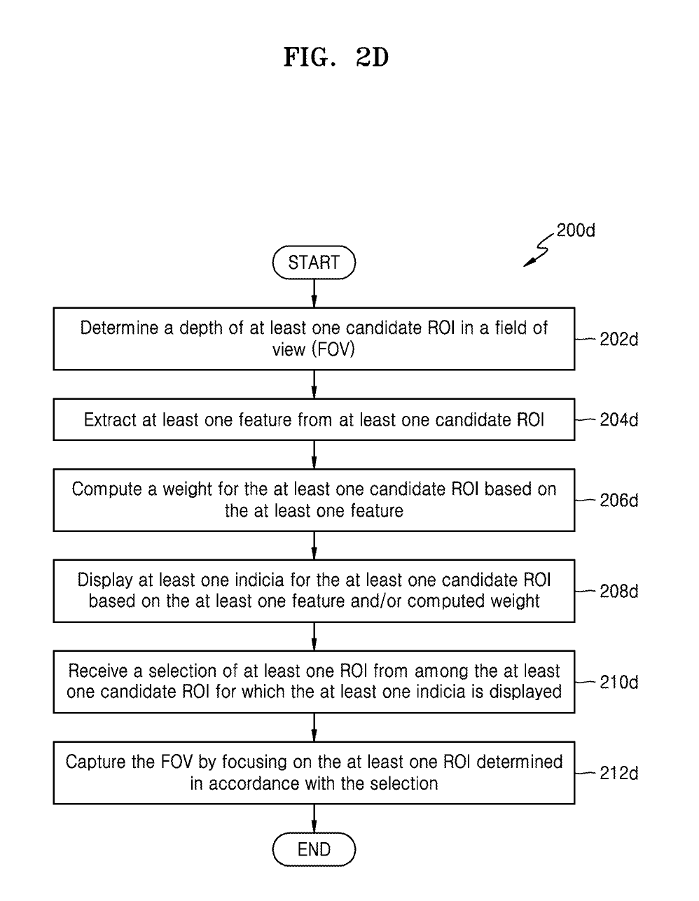

FIG. 2A is a flow diagram illustrating a method of automatically focusing on an ROI by an electronic device, according to an embodiment of the present disclosure.

Referring to FIG. 2A, the method 200a includes operation 202a of determining at least one candidate ROI in the FOV of the sensor 102 and the depth of the at least one candidate ROI. In an example embodiment, the sensor 102 may determine at least one candidate ROI in the FOV of the sensor 102 and the depth of the at least one candidate ROI. In another example embodiment, the controller 104 may determine the at least one candidate ROI in the FOV of the sensor 102 and the depth of the at least one candidate ROI.

The method 200a further includes operation 204a of displaying at least one indicia for each candidate ROI. An indicia of a candidate ROI may indicate the depth of the candidate ROI. In another example embodiment, the sensor 102 or the controller 104 may cause to display the at least one indicia for each candidate ROI. The indicia of a candidate ROI may indicate the depth of the candidate ROI.

Unlike the systems and methods of the related art, the proposed mechanism may perform the candidate ROI detection with respect to “N” objects, which differs from grid-based or region-based candidate ROI detection mechanism for autofocus.

The various actions, acts, blocks, operations, or the like in the method 200a may be performed in the order presented, in a different order, or simultaneously. Further, in some example embodiments, some of the actions, acts, blocks, operations, or the like may be omitted, added, modified, skipped, or the like without departing from the scope of the disclosure.

FIG. 2B is a flow diagram illustrating a method of automatically focusing on an ROI by an electronic device, according to an embodiment of the present disclosure.

Referring to FIG. 2B, the method 200b includes operation 202b of determining at least one candidate ROI in the FOV of the sensor 102 based on an RGB image, a depth, and a phase-based focal code. In an example embodiment, the sensor 102 may determine at least one candidate ROI in the FOV of the sensor 102 based on the RGB image, the depth, and the phase-based focal code. In another example embodiment, the controller 104 may determine at least one candidate ROI in the FOV of the sensor 102 based on an RGB image, and at least one of a depth and a phase-based focal code.

The method 200b includes operation 204b of displaying the at least one indicia for each candidate ROI. In an example embodiment, the sensor 102 or the controller 104 may cause to display at least one indicia for each candidate ROI. The sensor 102 or the controller 104 may cause to display the at least one indicia for each candidate ROI based on the weight associated with each candidate ROI. The indicia of a candidate ROI may indicate the depth of the candidate ROI, but is not limited thereto.

The various actions, acts, blocks, operations, or the like in the method 200b may be performed in the order presented, in a different order, or simultaneously. Further, in some example embodiments, some of the actions, acts, blocks, operations, or the like may be omitted, added, modified, skipped, or the like without departing from the scope of the disclosure.

FIG. 2C is a flow diagram illustrating a method of automatically focusing on an ROI by an electronic device, according to an embodiment of the present disclosure.

Referring to FIG. 2C, the method 200c includes operation 202c of extracting at least one feature from the at least one candidate ROI in a field of view (FOV) of a sensor in the electronic device. The method further includes operation 204c of displaying at least one indicia for the at least one candidate ROI based on the at least one feature, and operation 206c of receiving a selection of at least one ROI from among the at least one candidate ROI for which the at least one indicia is displayed. The method 200c further includes operation 208c of focusing on the at least one ROI according to the selection.

The various actions, acts, blocks, operations, or the like in the method 200c may be performed in the order presented, in a different order, or simultaneously. Further, in some example embodiments, some of the actions, acts, blocks, operations, or the like may be omitted, added, modified, skipped, or the like without departing from the scope of the disclosure.

FIG. 2D is a flow diagram illustrating a method of automatically focusing on an ROI by an electronic device, according to an embodiment of the present disclosure.

Referring to FIG. 2D, the method 200d includes operation 202d of determining a depth of at least one candidate ROI in a field of view (FOV). The method further includes operation 204d of extracting at least one feature from at least one candidate ROI, operation 206d of computing a weight for the at least one candidate ROI based on the at least one feature, operation 208d of displaying at least one indicia for the at least one candidate ROI based on the at least one feature and/or computed weight, and operation 210d of receiving a selection of at least one ROI from among the at least one candidate ROI for which the at least one indicia is displayed. The method 200d further includes operation 212d of capturing the FOV by focusing on the at least one ROI determined in accordance with the selection.

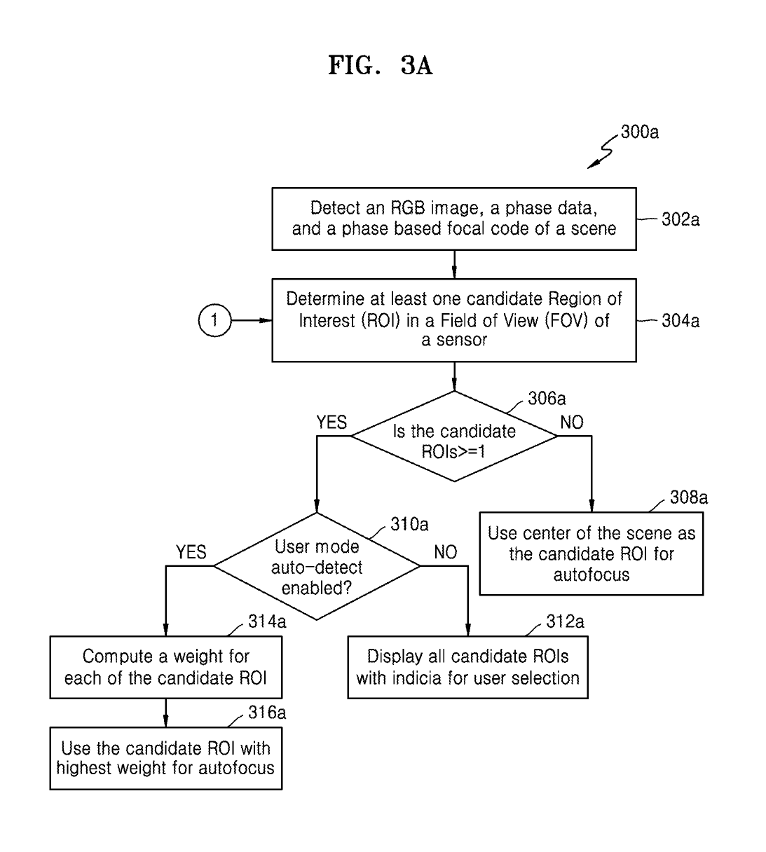

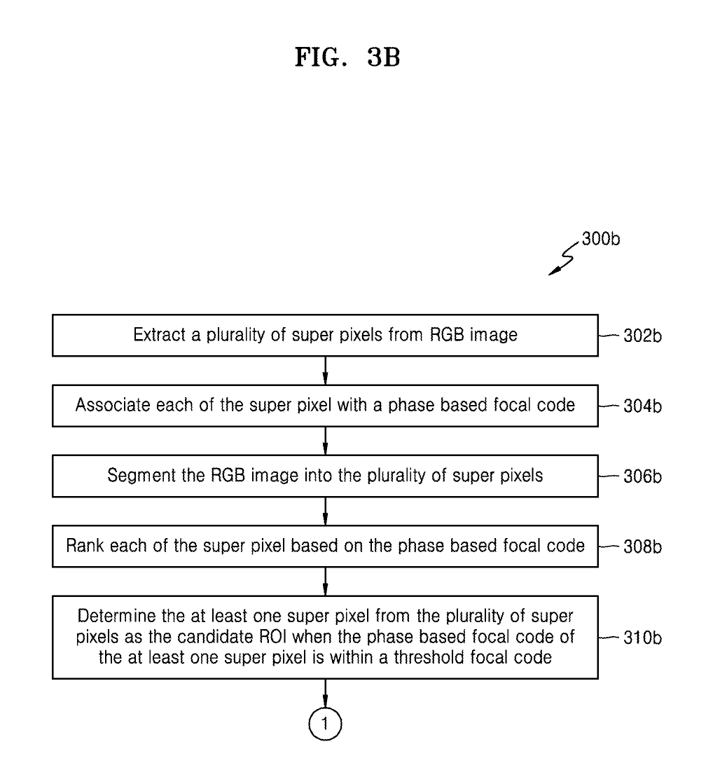

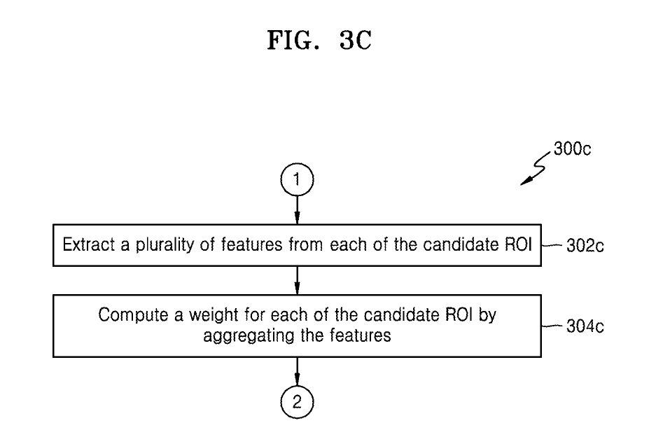

FIG. 3A is a flow diagram illustrating a method of automatically focusing on a candidate ROI having the highest weight by an electronic device, according to an embodiment of the present disclosure.

Referring to FIG. 3A, the method 300a includes operation 302a of detecting an RGB image, phase data, and a phase-based focal code of a scene. The sensor 102 or the controller 104 may detect the RGB image, the phase data, and the phase-based focal code of the scene.

The method 300a further includes operation 304a of determining at least one candidate ROI in the FOV of the sensor 102. In an example embodiment, the sensor 102 may determine at least one candidate ROI in the FOV of the sensor 102. In another example embodiment, the controller 104 may determine at least one candidate ROI in the FOV of the sensor 102. The method further includes operation 306a of determining whether the number of candidate ROIs is greater than or equal to one. At operation 306a, if the determined number of candidate ROIs is not greater than or equal to one, then the method 300a proceeds to operation 308a of using the center of the scene as the candidate ROI for autofocus. In an example embodiment, the sensor 102 may use the center of the scene as the candidate ROI for autofocus. In another example embodiment, the controller 104 may use the center of the scene as the candidate ROI for autofocus.

At operation 306a, if the determined number the candidate ROIs is greater than or equal to one, then the method 300a proceeds to operation 310a of determining whether user mode auto-detect is enabled. The user mode auto-detect may be further divided into two modes which are (1) ROI auto-weighting mode and (2) ROI auto-focus mode based on a user selection.

At operation 310a, if it is determined that the user mode auto-detect is not enabled, the method 300a proceeds to operation 312a of displaying the candidate ROIs, along with the indicia corresponding to each candidate ROI, for user selection. In an example embodiment, the sensor 102 may display the candidate ROIs, along with the indicia corresponding to each candidate ROI, for user selection. In another example embodiment, the controller 104 may display the candidate ROIs, along with the indicia corresponding to each candidate ROI, for user selection. The method 300a may rank candidate ROIs based on the indicia, but the rankings are not limited thereto. For example, the rankings may be derived based on depths or saliency weights of candidate ROIs. Each of the indicia may be color coded or shape coded.

At operation 310a, if it is determined that the user mode auto-detect is enabled, the method 300a proceeds to operation 314a of computing weights for the candidate ROIs. In an example embodiment, the sensor 102 may compute the weights for the candidate ROIs. In another example embodiment, the controller 104 may compute the weights for the candidate ROIs. Following operation 314a, the method 300a may proceed to operation 316a of auto-focusing on the candidate ROI with the highest weight. In an example embodiment, the sensor 102 may use the candidate ROI having the highest weight for auto-focusing. In another example embodiment, the controller 104 may use the candidate ROI having the highest weight for auto-focusing.

The various actions, acts, blocks, operations, or the like in the method 300a may be performed in the order presented, in a different order, or simultaneously. Further, in some example embodiments, some of the actions, acts, blocks, operations, or the like may be omitted, added, modified, skipped, or the like without departing from the scope of the disclosure.

FIG. 3B is a flow diagram illustrating a method of determining at least one candidate ROI, according to an embodiment of the present disclosure.

Referring to FIG. 3B, the method 300b includes operation 302b of extracting a plurality of clusters from the RGB image. A cluster, which may also be referred to herein as a super pixel, may be a cluster of pixels included in the RGB image. In an example embodiment, the sensor 102 may extract a plurality of clusters from the RGB image. In another example embodiment, the controller 104 may extract a plurality of clusters from the RGB image.

The method 300b includes operation 304b of associating each of the clusters with a phase-based focal code. In an example embodiment, the sensor 102 may associate each of the clusters with a phase-based focal code. In another example embodiment, the controller 104 may associate each of the clusters with a phase-based focal code. The method 300b includes operation 306b of segmenting the RGB image into the plurality of clusters based on color and phase depths of the plurality of clusters, for example, based on the color and the phase depth similarity. In an example embodiment, the sensor 102 may segment the RGB image into the plurality of clusters based on color and phase depths of the plurality of clusters, for example, based on the color and the phase depth similarity. In another example embodiment, the controller 104 may segment the RGB image into the plurality of clusters based on color and phase depths of the plurality of clusters, for example, based on the color and the phase depth similarity.

The method 300b includes operation 308b of ranking each of the clusters based on phase-based focal codes corresponding to the clusters. In an example embodiment, the sensor 102 may rank each of the clusters based on the phase-based focal codes. In another example embodiment, the controller 104 may rank each of the clusters based on the phase-based focal codes. The method 300b includes operation 310b of determining at least one candidate ROI based on the phase-based focal codes of the plurality of clusters and a threshold focal code value. For example, the sensor 102 or the controller 104 may set one or more of the clusters as a candidate ROI based on which of the phase-based focal codes is below the threshold focal code value, but is not limited thereto. For example, the sensor 102 or the controller 104 may set one or more of the clusters as a candidate ROI based on which of the phase-based focal codes is above the threshold focal code value, or based on which of the phase-based focal codes is within a range of focal code values.

In an example embodiment, after performing operations 302b to 308b as described above, operation 306a is performed as described in conjunction with FIG. 3A.

The various actions, acts, blocks, operations, or the like in the method 300b may be performed in the order presented, in a different order, or simultaneously. Further, in some example embodiments, some of the actions, acts, blocks, operations, or the like may be omitted, added, modified, skipped, or the like without departing from the scope of the disclosure.

FIG. 3C is a flow diagram illustrating a method of computing a weight for each candidate ROI, according to an embodiment of the present disclosure.

Referring to FIG. 3C, the method 300c includes operation 302c of extracting one or more features from each candidate ROI. In an example embodiment, the sensor 102 may extract one or more features from each candidate ROI. In another example embodiment, the controller 104 may extract one or more features from each candidate ROI.

The method 300c includes operation 304c of computing the weight for each candidate ROI, for example, by aggregating the features. In an example embodiment, the sensor 102 may compute the weight for each candidate ROI by aggregating the features. In another example embodiment, the controller 104 may compute the weight for each candidate ROI by aggregating the features. In an example embodiment, the features include at least one of region variance, a color distribution, a facial feature, a region size, a category score, a focal distance, and feature data of stored images.

In an example embodiment, a facial feature weight (W_{F}) may be computed for a face included in the RGB image based on face size with respect to the RGB image or face size with respect to a frame size. Further, additional features such as a smile can affect (for example, increase or decrease) the weight computed for the face. The weight can be normalized to a value from 0-1.

In an example embodiment, color distribution weight (W_{C}) is computed based on the degree in which the color of each ROI differs from the background color. Initially, the color distribution according to regions other than the candidate ROIs using histograms (Hb) is determined using Equation 1 below:

$${W}_{c} = \frac{{\sum }_{i ∈ roi} ( 1 - Hb ( roi ( i ) ) )}{area ( roi )} \qquad Equation 1$$

In an example embodiment, region variance (W_{R}) may be defined as the ratio between the ROI variance and global image variance. The region variance can be normalized to a value from 001.

In an example embodiment, the focal distance (W_{FD}) may be based on the normalized weights of 0-1 assigned to the ROIs. Alternatively, the focal distance (W_{FD}) may be based on the focal codes of 0-1 assigned to the ROIs. In the focal distance (W_{FD}), “1” may indicate an ROI close to the sensor 102.

In an example embodiment, the weight may be computed for each candidate ROI by combining the above weights using Equation 2 below:

$${W}_{ROI} = \frac{( {W}_{c} + {W}_{R} + {W}_{FD} ) β + ( 1 - β ) {W}_{F}}{4} \qquad Equation 2$$

In Equation 2, β is used to set a face priority value from 0-1. In one example, the lower the β value, the higher the face priority.

The various actions, acts, blocks, operations, or the like in the method 300c may be performed in the order presented, in a different order, or simultaneously. Further, in some example embodiments, some of the actions, acts, blocks, operations, or the like may be omitted, added, modified, skipped, or the like without departing from the scope of the disclosure.

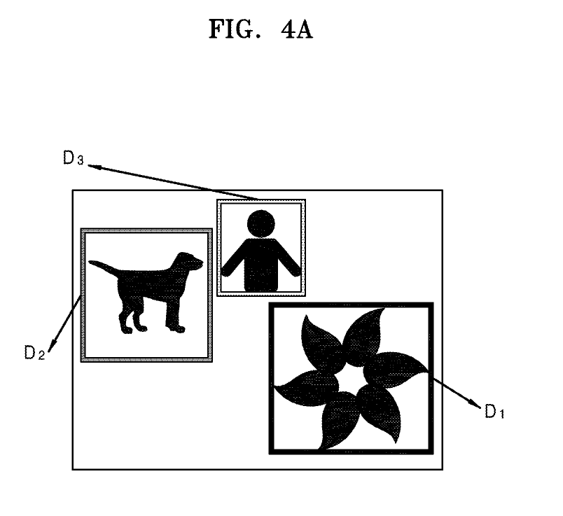

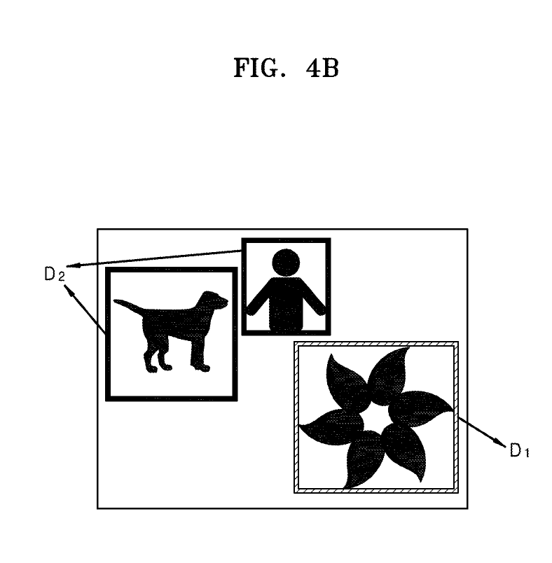

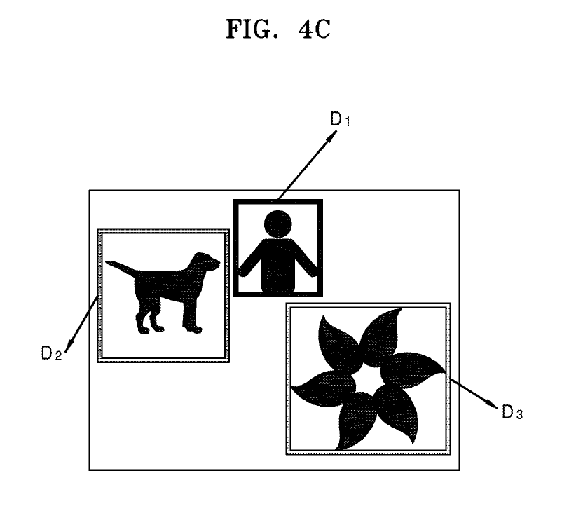

FIGS. 4A through 4C illustrate an example of computing a weight of at least one candidate ROI using feature data of stored images, according to various embodiments of the present disclosure.

Referring to FIG. 4A, a flower in the FOV of the sensor 102 is located at a depth “D₁”, an animal in the FOV of the sensor 102 is located at a depth “D₂”, and a person in the FOV of the sensor 102 is located at a depth “D₃” sensor. Further, if “D₁”<<“D₂”<<“D₃”, and the size of the flower is much larger than the size of the animal and the size of the person which is the combined size of the animal and the person, the flower will be ranked higher than (e.g., assigned a higher weight than) both the person and the animal and the sensor 102 will focus according to the depth “D₁”.

Referring to FIG. 4B, if “D₁”<<“D₂”, and the combined size of the person and the animal is much smaller than the size of the flower, the weight of the animal and the weight of the person will be added as weight for “D₂”. Further, if the weight for “D₂”>the weight for “D₁”, the sensor 102 will focus according to the depth “D₂”.

Referring to FIG. 4C, since the classification of objects is the most important factor in computing the weight, a person in the FOV of the sensor 102 is located at a depth D1 in case that the classification is set or selected by a user to put more weight on a person. The animal in the FOV is given the second weight and thus is located at a depth D2. The flower is given the third weight and thus is located at a depth D3. The face or body of the person is recognized by the sensor 102 based on face/body recognition algorithm

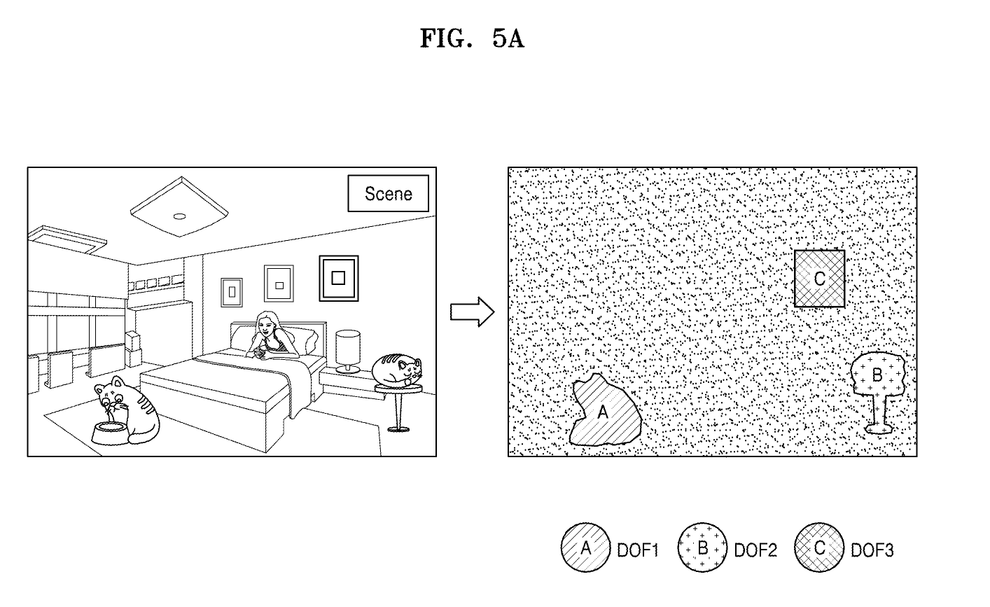

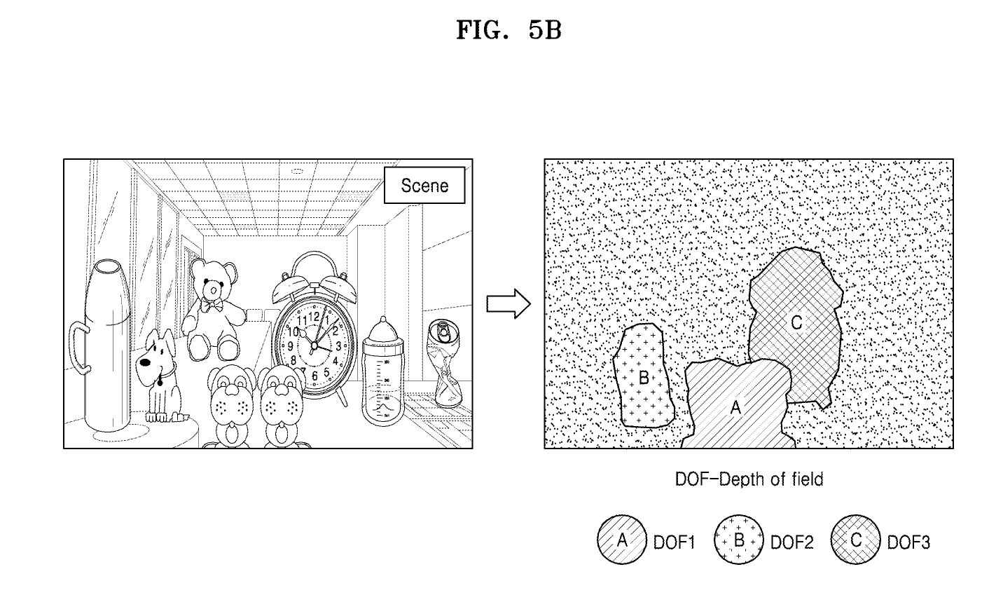

FIGS. 5A and 5B illustrate an example of identifying phase-based focal regions, according to various embodiments of the present disclosure.

Referring to FIGS. 5A and 5B, the focal regions “A”, “B”, and “C” in the FOV are at different distances (i.e., have different focal code values) from a camera. The values in the phase data indicate respective distances between objects in the focal regions of the focus area and the camera. The focal region currently in focus is assigned the highest focal code value, and the remaining focal regions are assigned focal code values indicating relative distance from the camera or are assigned focal code values different from that of the focal region currently in focus. These values may be used to improve clustering performance. By coupling the phase data with the focal codes, the phase data may be used to assign the depth values to each cluster in the FOV.

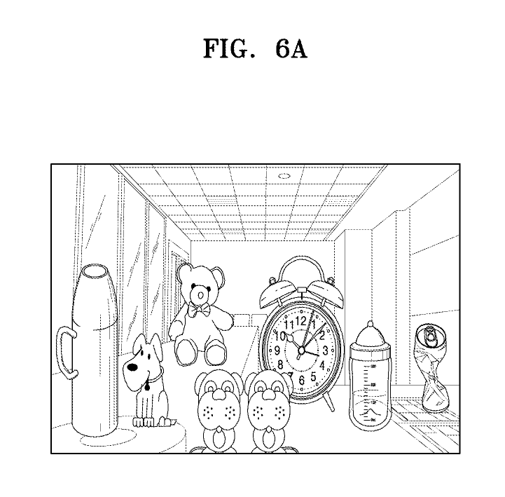

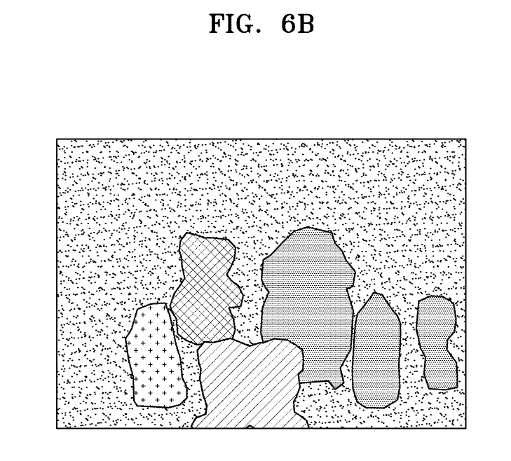

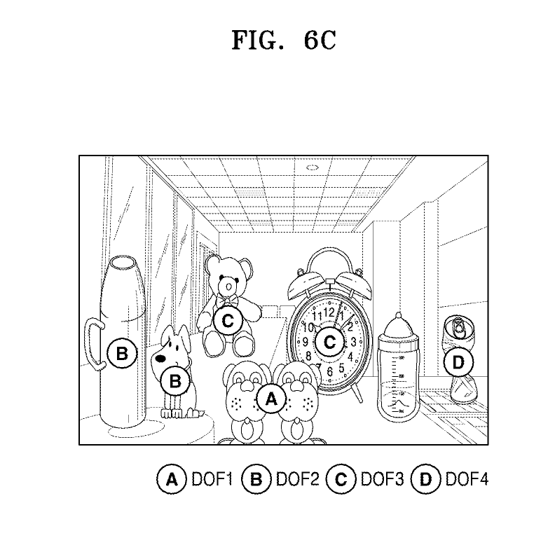

FIGS. 6A to 6C illustrate an example of displaying at least one indicia for each candidate ROI, according to various embodiments of the present disclosure.

Referring to FIGS. 6A to 6C, FIG. 6A shows a scene, FIG. 6B shows the same scene, but represented by pixels assigned depth values relative to focal codes corresponding to the pixels and the current focus region, and FIG. 6C shows the focal regions in the FOV at different distances from the camera and the distances between objects in the regions and the camera are represented by “A”, “B”, “C”, and “D”. The focal region currently in focus is assigned the highest focal code value, and the remaining focal regions are assigned focal code values indicating relative distance from the focal region currently in focus or are assigned focal codes different from that of the focal region currently in focus.

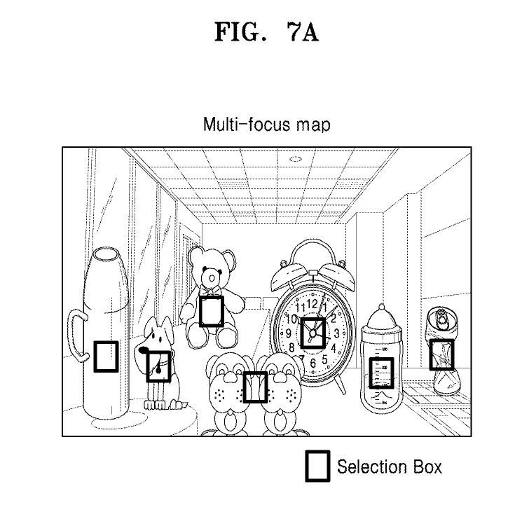

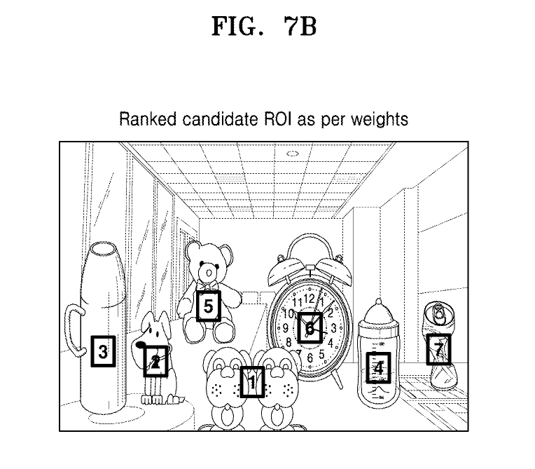

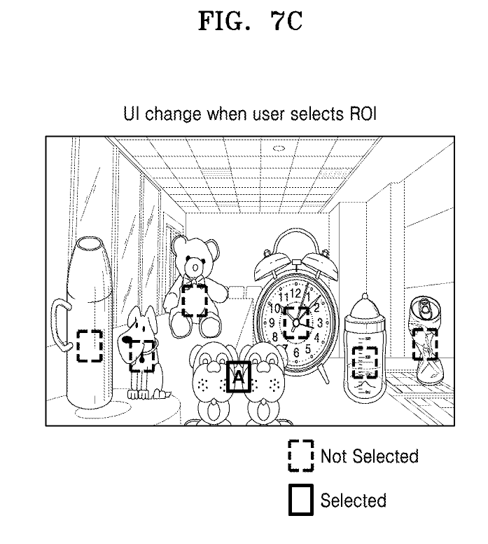

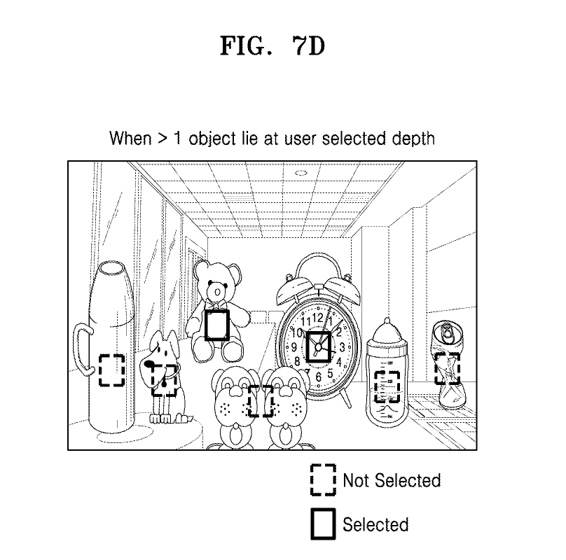

FIGS. 7A to 7D illustrate an example of displaying at least one candidate ROI for user selection, according to various embodiments of the present disclosure.

Referring to FIG. 7A, by using the phase data and the RGB image, the candidate ROIs (i.e., objects) at different depths with unique focal codes may be identified. The determined candidate ROIs are displayed to the user along with selection boxes corresponding to the candidate ROIs. The user may select any of the candidate ROIs for the sensor 102 or controller 104 to focus on, for example, via the selection boxes.

Referring to FIG. 7B, the weight for each candidate ROI is computed based on the features of each candidate ROI, for example, by aggregating the features. After computing the weight for each candidate ROI, the candidate ROIs may be ranked in ascending order with respect to depth. However, the example embodiment is not limited thereto, and the candidate ROIs may be ranked in descending order with respect to depth. Referring to FIG. 7C, when the user selects the selection box (denoted “A”) of a candidate ROI, the selection boxes of the remaining candidate ROIs are displayed differently compared to the selection box of the selected candidate ROI (e.g., the selection boxes for non-selected candidate ROIs are changed to a color different from that of the selection box of the selected candidate ROI). Referring to FIG. 7D, for any two or more candidate ROIs having the same weight (i.e., candidate ROIs assigned the same rank with respect to depth), the selection boxes for those two or more candidate ROIs will also be same (e.g., selection boxes having the same color, shape, size, line thickness, etc.).

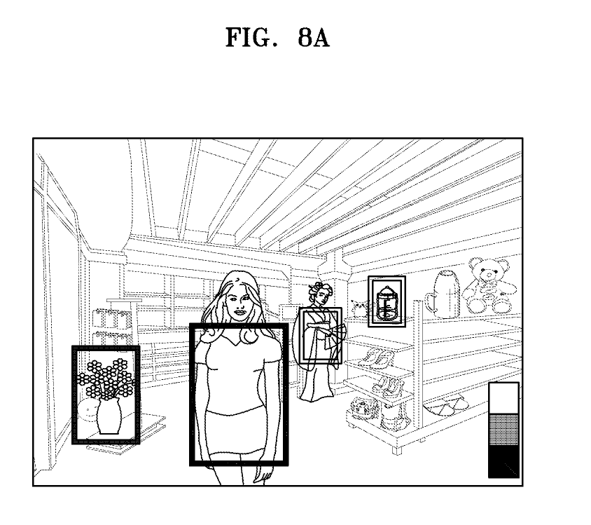

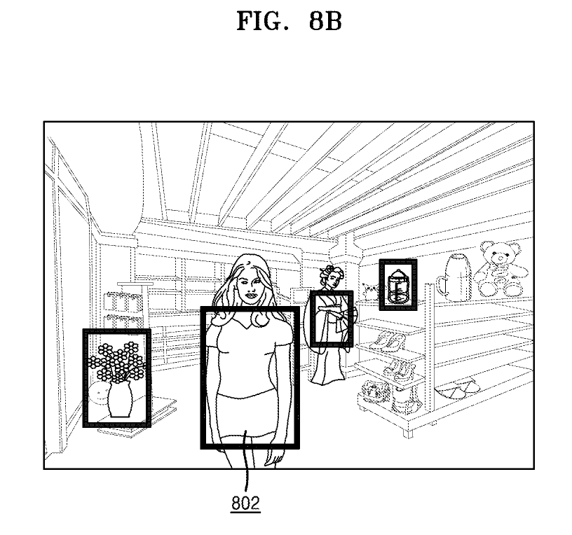

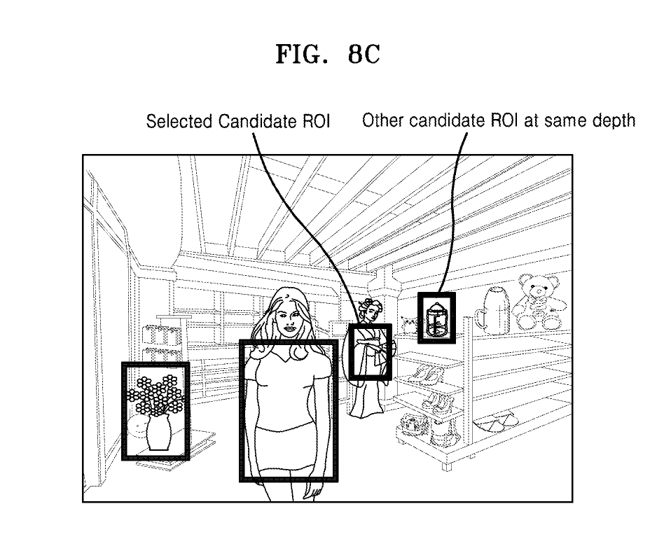

FIGS. 8A to 8C illustrate an example of displaying candidate ROIs for user selection, according to an embodiment of the present disclosure.

Referring to FIG. 8A, the candidate ROIs are displayed with selection boxes (e.g., indicia), and the user may select any of the candidate ROIs for the sensor 102 or controller 104 to focus on, for example, via the selection boxes. Referring to FIG. 8B, the user selects the candidate ROI 802, and the selection boxes of the selected candidate ROI 802 and the selection boxes of the non-selected candidate ROIs are color coded differently from one another. Referring to FIG. 8C, when the user selects a candidate ROI, the selection box of the selected candidate ROI is color coded differently from selection boxes of unselected candidate ROIs, except for any unselected candidate ROIs located at the same depth as the selected candidate ROI. For example, the selection box of an unselected candidate ROI at the same depth as the selected candidate ROI may be the same color as the selection box of the selected candidate ROI. Accordingly, the selected candidate ROI and any unselected ROIs at the same depth as the selected candidate ROI are color coded differently from other ROIs. The above example is not limited thereto, and the selection boxes may be differentiated according to color, shape, size, line thickness, etc.

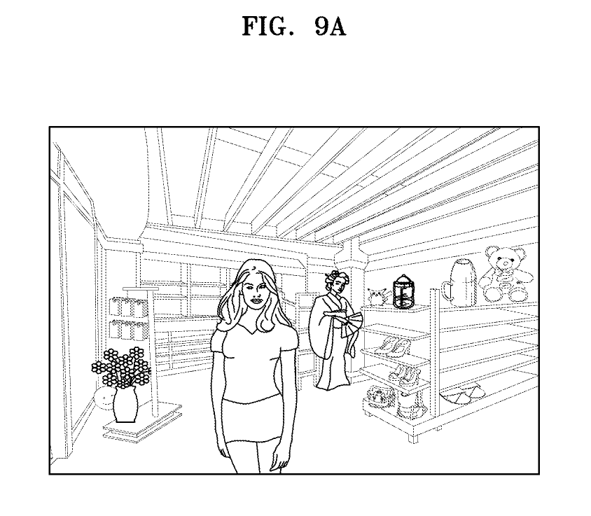

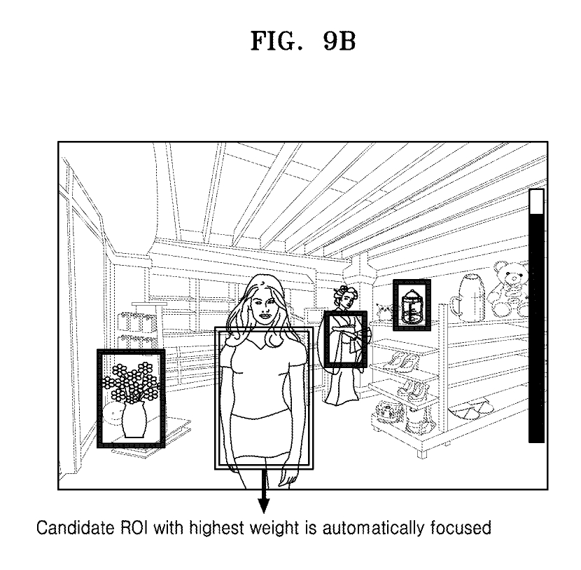

FIGS. 9A and 9B illustrate an example of automatically focusing on an ROI having the highest weight, according to various embodiments of the present disclosure.

Referring to FIG. 9A, the sensor 102 detects the RGB image, phase data, and a phase-based focal code of the scene in the FOV of the sensor 102. Further, the sensor 102 determines the candidate ROIs in the FOV of the sensor 102. If user mode auto-detect is enabled, the sensor 102 extracts one or more features from each candidate ROI and computes a weight for each candidate ROI based on the features, for example, by aggregating the features. Referring to FIG. 9B, the sensor 102 focuses on the candidate ROI having the highest weight. As previously disclosed, the detection of the RGB image, the phase data, and the phase-based focal code, the determination of the candidate ROIs, the extraction of features, the computation of weights, and the focusing on the candidate ROI having the highest weight may also be performed by the controller 104 as well.

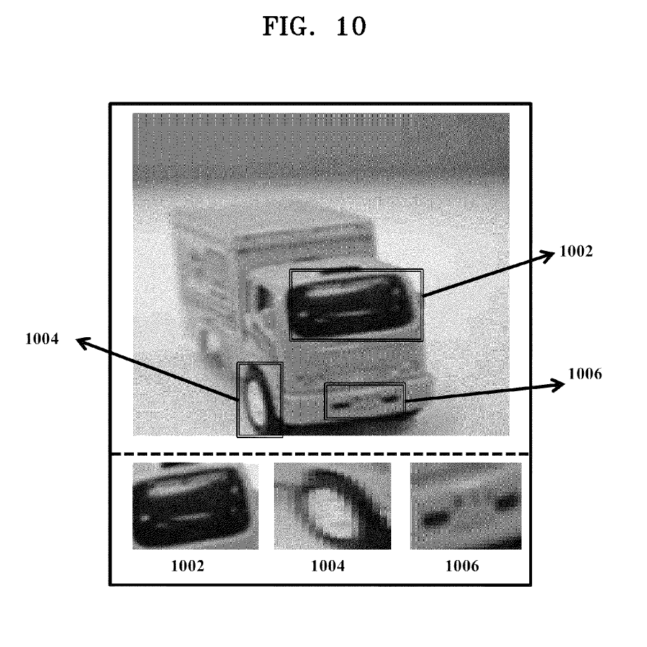

FIG. 10 illustrates an example of a macro shot with image capture, according to an embodiment of the present disclosure.

Referring to FIG. 10, an alternate user interface (UI) is shown in which different regions which may be focused on (e.g., regions denoted by 1002, 1004, and 1006) are extracted from the image and displayed to the user, separate from the main picture, for selection. Further, bounding boxes or indicators may be displayed along with the regions 1002, 1004, and 1006 included in the main picture (e.g., overlapping or next to the regions) to indicate where the different regions are located with respect to the scene.

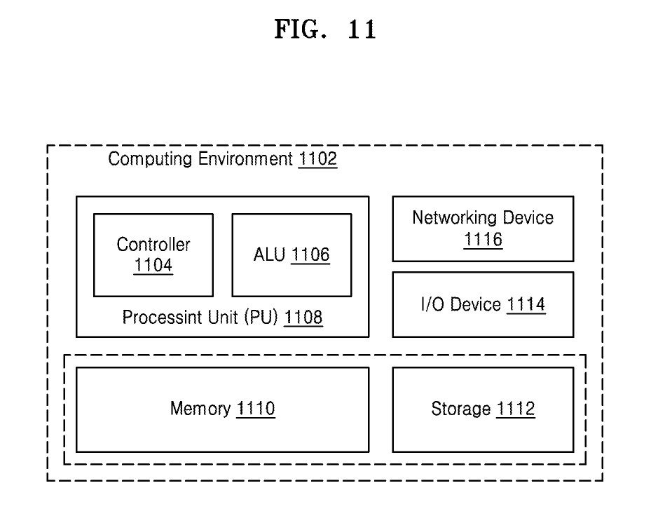

FIG. 11 illustrates a computing environment implementing a method and system for automatically focusing on an ROI by an electronic device, according to an embodiment of the present disclosure.

Referring to FIG. 11, the computing environment 1102 includes at least one processing unit 1108 that is equipped with a controller 1104 and an arithmetic logic unit (ALU) 1106, a memory 1110, a storage unit 1112, one or more network devices 1116 and one or more input/output (I/O) devices 1114. The processing unit (or processor) 1108 is responsible for and may process the instructions of the example embodiments described herein. The processing unit 1108 may process the instructions in accordance with commands which the processing unit 1108 receives from the controller 1104. Further, any logical and arithmetic operations involved in the execution of the instructions may be computed with assistance from the ALU 1106.

The overall computing environment 1102 may be composed of multiple homogeneous or heterogeneous cores, multiple central processing units (CPUs) of different types, special media and other accelerators. Further, the plurality of processing units 1108 may be located on a single chip or on multiple chips.

The instructions and code for implementing the example embodiments of the present disclosure described herein may be stored in either the memory unit 1110 or the storage 1112 or both. The instructions may be fetched from the memory unit 1110 or storage 1112 and executed by the processing unit 1108.

In the case of any hardware implementations, various network devices 1116 or external I/O devices 1114 may connect to the computing environment and support the implementation.

The example embodiments disclosed herein may be implemented through at least one software program running on at least one hardware device and performing network management functions for controlling the elements. The elements shown in the figures may be implemented by at least one of a hardware device, or a combination of a hardware device and software units.

The foregoing description of the specific example embodiments will so fully reveal the general nature of the example embodiments herein that others can, by applying current knowledge, readily modify or adapt, for various applications, the disclosed example embodiments without departing from the generic concepts thereof, and, therefore, such adaptations and modifications should and are intended to be comprehended within the meaning and range of equivalents of the disclosed example embodiments. It is to be understood that the phraseology or terminology employed herein is for the purpose of description and not of limitation.

While the present disclosure has been shown and described with reference to the various embodiments thereof, it will be understood by those skilled in the art that various changes in form and details may be made therein without departing from the spirit and scope of the present disclosure as defined by the appended claims and their equivalents.

What is claimed is:

1. A method of automatically focusing on a region of interest (ROI) by an electronic device, the method comprising:
extracting at least one feature from at least one candidate ROI in a field of view (FOV) of a sensor in the electronic device;
displaying at least one indicia for the at least one candidate ROI based on the at least one feature;
receiving a selection of at least one ROI from among the at least one candidate ROI for which the at least one indicia is displayed; and
focusing on the at least one ROI according to the selection.

2. The method of claim 1, further comprising:
determining a depth of the at least one candidate ROI; and
computing a weight for the at least one candidate ROI based on the at least one feature,
wherein the at least one indicia indicates at least one of the depth of the at least one candidate ROI, the at least one feature and the weight.

3. The method of claim 1, wherein the at least one feature comprises at least one of a region variance, a color distribution, a facial feature, a region size, a category score, a focal distance, a speed of an object included in the at least one candidate ROI, a size of the object, a category of the object and feature data of stored images.

4. The method of claim 3, wherein the at least one feature is set or selected by a user for computing a weight for the at least one candidate ROI.

5. The method of claim 2, wherein the determining of the depth of the at least one candidate ROI comprises:
detecting a red, green, blue (RGB) image, phase data, and at least one phase-based focal code;
identifying a plurality of clusters included in the RGB image;
ranking the clusters based on the phase-based focal codes corresponding to the clusters; and
determining the at least one candidate ROI based on the phase-based focal codes of the plurality of clusters and a threshold focal code value, and
wherein the determining of the at least one candidate ROI includes setting at least one of the clusters as a candidate ROI based on the phase-based focal codes and the threshold focal code value.

6. The method of claim 5, wherein the identifying of the plurality of clusters comprises:
extracting the plurality of clusters from the RGB image;
associating each of the clusters with a phase-based focal code; and
segmenting the RGB image based on color and phase depths of the plurality of clusters.

7. The method of claim 1, further comprising:
capturing the FOV by the focusing on the at least one ROI.

8. A method of automatically focusing on a region of interest (ROI) by an electronic device, the method comprising:
determining at least one candidate ROI in a field of view (FOV) of a sensor in the electronic device based on a red, green, blue (RGB) image and at least one of a depth and a phase-based focal code corresponding to the at least one candidate ROI; and
displaying at least one indicia for the at least one candidate ROI.

9. The method of claim 8, wherein the displaying of the at least one indicia comprises:
displaying the at least one indicia based on a weight associated with the at least one candidate ROI.

10. The method of claim 8, wherein the at least one indicia indicates the at least one of the depth of the at least one candidate ROI.

11. An electronic device for automatically focusing on a region of interest (ROI), the electronic device comprising:
a sensor; and
a processor configured to:
extract at least one feature from at least one candidate ROI in a field of view (FOV) of a sensor,
receive a selection of at least one ROI from among the at least one candidate ROI for which at least one indicia is displayed based on the at least one feature, and
focus on the at least one ROI according to the selection.

12. The electronic device of claim 11, wherein the processor is further configured to:
determine a depth of the at least one candidate ROI, and
compute a weight for the at least one candidate ROI based on the at least one feature,
wherein the at least one indicia indicates at least one of the depth of the at least one candidate ROI, the at least one feature and the weight.

13. The electronic device of claim 11, wherein the at least one feature comprises at least one of a region variance, a color distribution, a facial feature, a region size, a category score, a focal distance, and feature data of stored images.

14. The electronic device of claim 11, wherein the processor is further configured to:
detect a red, green, blue (RGB) image, phase data, and at least one phase-based focal code,
identify a plurality of clusters included in the RGB image,
rank the clusters based on the phase-based focal codes corresponding to the clusters,
determine the at least one candidate ROI based on the phase-based focal codes of the plurality of clusters and a threshold focal code value, and
set at least one of the clusters as a candidate ROI based on the phase-based focal codes and the threshold focal code value.

15. The electronic device of claim 14, wherein, in the identifying of the plurality of clusters, the processor is further configured to:
extract the plurality of clusters from the RGB image,
associate each of the clusters with a phase-based focal code, and
segment the RGB image into the plurality of clusters based on color and phase depths of the plurality of clusters.

16. A non-transitory computer-readable storage medium storing instructions thereon that, when executed, cause at least one processor to perform a method, the method comprising:
extracting at least one feature from at least one candidate ROI in a field of view (FOV) of a sensor in an electronic device;
displaying at least one indicia for the at least one candidate ROI based on the at least one feature;
receiving a selection of at least one ROI from among the at least one candidate ROI for which the at least one indicia is displayed; and
focusing on the at least one ROI according to the selection.

17. The non-transitory computer-readable storage medium of claim 16, the method further comprising:
determining a depth of the at least one candidate ROI; and
computing a weight for the at least one candidate ROI based on the at least one feature,
wherein the at least one indicia indicates at least one of the depth of the at least one candidate ROI, the at least one feature and the weight.

18. The non-transitory computer-readable storage medium of claim 16, wherein the at least one feature comprises at least one of a region variance, a color distribution, a facial feature, a region size, a category score, a focal distance, a speed of an object included in the at least one candidate ROI, a size of the object, a category of the object and feature data of stored images.

19. The non-transitory computer-readable storage medium of claim 18, wherein the at least one feature is set or selected by a user for computing a weight for the at least one candidate ROI.

20. The non-transitory computer-readable storage medium of claim 17, wherein the determining of the depth of the at least one candidate ROI comprises:
detecting a red, green, blue (RGB) image, phase data, and at least one phase-based focal code;
identifying a plurality of clusters included in the RGB image;
ranking the clusters based on the phase-based focal codes corresponding to the clusters; and
determining the at least one candidate ROI based on the phase-based focal codes of the plurality of clusters and a threshold focal code value, and
wherein the determining of the at least one candidate ROI includes setting at least one of the clusters as a candidate ROI based on the phase-based focal codes and the threshold focal code value.
